(19) United States
(12) Patent Application Publication
(10) Pub. No.: US 2003/0072289 A1
(43) Pub. Date: Apr. 17, 2003

(54) Quality-of-service guaranteed media access control method with dynamic granularity control for local wireless ATM networks

(76) Inventors: Maria Yuang, Taipei (TW); Bird Lo, Taipei (TW); Yu Guo Chen, Taipei (TW)

Correspondence Address: FISH & RICHARDSON PC, 225 FRANKLIN ST, BOSTON, MA, 02110, US

(21) Appl. No.: 09/978,369

(22) Filed: Oct. 16, 2001

(51) Int. Cl. H04Q 7/24

(52) U.S. Cl. 370/338; 370/395.21; 370/395.53

(57) ABSTRACT

In a quality-of-service guaranteed media access control method with dynamic granularity control for local wireless ATM networks, reservation bandwidth is allocated in accordance with a weight-based scheduling policy. Based on a neural-fuzzy prediction technique, the favorable bandwidth implying maximum throughput is derived. The smaller value between the reservation and the favorable bandwidth is allocated as the contention bandwidth of the frame.

### BACKGROUND OF THE INVENTION

1. Field of the Invention

The present invention relates to a media access control method used in local wireless ATM networks and, more particularly, to a quality-of-service guaranteed media access control method with dynamic granularity control for local wireless ATM networks.

2. Description of Related Art

With the rapid proliferation of personal communication services provided to multimedia portable computers, wireless access to existing networks has emerged as a significant concern. Essentially, wireless ATM has been envisioned as a potential framework for next-generation wireless networks capable of supporting integrated multimedia services with a wide range of services rates and different quality of service (QoS). Expected supported services include constant bit rate (CBR), variable bit rate (VBR), and available bit rate (ABR). Examples of QoS requirement for VBR and ABR traffic are bounded delay and minimum cell rate (MCR), respectively. A major challenge pertaining to such wireless ATM networks is the design of a medium access control (MAC) protocol achieving multiple access efficiency and QoS guarantees.

Existing MAC classes, such as time-division multiple access (TDMA) and code-division multiple access (CDMA) exhibit various performance merits and weaknesses. TDMA can be further categorized as either frequency-division-duplex (FDD), in which uplink and downlink traffic are carried by two distinct carrier frequencies, or time-division-duplex (TDD), where only one common carrier frequency is used. Moreover, TDMA operates in one of three different manners: reservation-based, random-access-based, or the combination (hybrid-based). Compared to the former two schemes, the hybrid-based TDMA has been considered most promising. In essence, reservation access is indubitably favorable for guaranteed (e.g. CBR/VBR) services, whereas random access is suitable for making reservation. Such reservation traffic is hereinafter referred as reservation request (RVR) traffic.

Furthermore, medium bandwidth is generally shared on a frame basis. Most schemes proposed in the literature advocate the use of a fixed sharing granularity (frame size). Using a simple fixed-size frame, the QoS can be guaranteed for traditional CBR voice traffic only. If it is desired to provide dynamic bandwidth allocation among CBR/VBR/ABR traffic via fixed granularity, there is a noticeable increase in VBR delay in the presence of heavier CBR loads, and thus the QoS can not be guaranteed. Accordingly, it is desirable to provide an improved method to effectively guarantee the QoS.

### SUMMARY OF THE INVENTION

The object of the present invention is to provide a QoS guaranteed media access control method with dynamic granularity control for local wireless ATM networks, which results in dynamic change of frame granularity adapting to traffic fluctuation, thereby achieving bandwidth-on-demand while retaining maximal throughput.

To achieve the object, the media access control method of the present invention is used in local wireless ATM networks to guarantee the quality of service by dynamically control the size of frame. The ATM network transmits information via a sequence of frames. The method comprises: (A) using a neural fuzzy traffic prediction (NFTP) network to predicts ĝₙ at a time representing an end of the RB of frame n, where ĝₙ is the predicted value of gₙ, and gₙ denotes a normalized offered load of the reservation request traffic that is activated within interval from the contention bandwidth of frame n−1 to the reservation bandwidth of frame n; (B) based on ĝₙ, deriving favorable bandwidth (FB) of frame n and the contention bandwidth of frame n, wherein the favorable bandwidth is defined as a bandwidth capable of being allocated by remaining unreserved bandwidth of a maximum-sized frame satisfying the most stringent quality of service requirement; the remaining unreserved bandwidth is the bandwidth of the maximum-sized frame subtracted by allocated reservation bandwidth; the favorable bandwidth of frame n is defined as the number of slots allocated in the contention bandwidth of frame n, such that the contention bandwidth has a maximum steady-state throughput; (C) at the end of contention bandwidth of frame n, constructing learning data in accordance with actual bandwidth allocation for being input to the neural fuzzy traffic prediction network to perform a learning operation.

Other objects, advantages, and novel features of the invention will become more apparent from the following detailed description when taken in conjunction with the accompanying drawings.

### BRIEF DESCRIPTION OF THE DRAWINGS

FIG. 1 shows the frame and slot structures in the channel of the wireless ATM network using the present media access control method;

FIG. 2 shows the flow of dynamic granularity control on contention bandwidth allocation in accordance with the present media access control method;

FIG. 3 shows a graph for determining the favorable bandwidth; and

FIG. 4 shows a graph for identifying the real offered load at the end of the contention bandwidth.

### DETAILED DESCRIPTION OF THE PREFERRED EMBODIMENT

The multiple access control method in accordance with the present invention is provided to operate in the base station (BS) of an infrastructure-based wireless ATM network. An uplink channel is provided between the base station and a mobile terminal (MT), so as to transfer information from mobile terminals (MT's) to the BS. The time on the uplink channel is divided into a contiguous sequence of fixed-size TDMA (Time Division Multiple Access) frames.

The wireless architecture for performing the multiple access control method in accordance with the present invention is the classical cell with a base station (BS) serving a finite set of mobile terminals (MT's) by means of a shared radio medium. On the basis of FDD, the medium bandwidth is divided into two separate channels: uplink and downlink. The uplink channel transfers information from MT's to the BS according to the present method. The downlink channel typically broadcasts information and acknowledges previous transmissions made on the uplink channel. Furthermore, time on the uplink channel is divided into a contiguous sequence of variable-size TDMA frames, comprising different numbers of ATM slots, each having multiple bytes (for example 53 bytes).

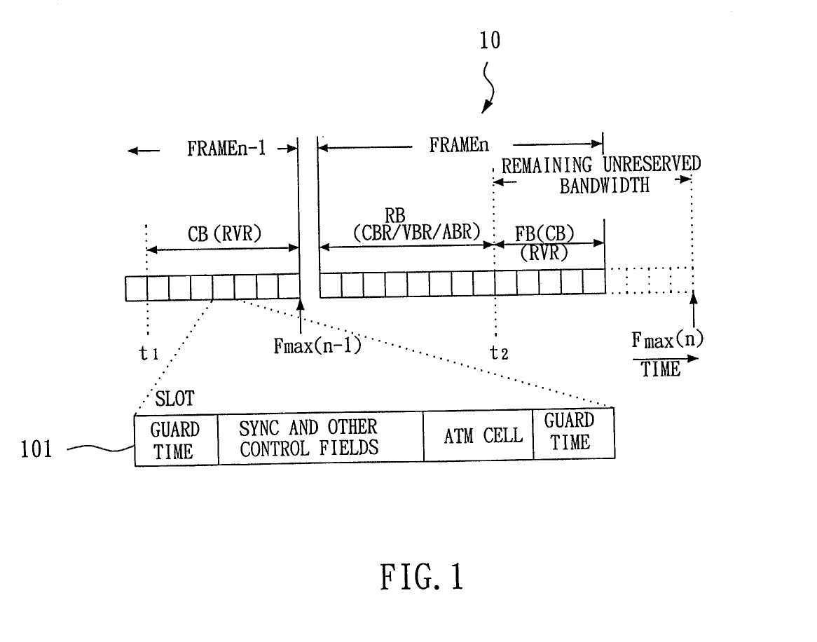

FIG. 1 shows the frame and slot structures in the channel. As shown, each frame 10 contains different amount of the reservation bandwidth (RB) and contention bandwidth (CB) in units of slots 101. The present method supports four types of traffic—CBR, VBR, ABR, and RVR, wherein CBR/VBR/ABR is governed by reservation access over the RB, RVR traffic is conducted by contention access (such as controlled-ALOHA random access) over the CB.

Each slot 101 of the frame 10 contains a data packet or, more specifically, an ATM cell, other than guard times, sync and other control fields. With guard times provided, the propagation delay between the BS and MT's can be ignored.

As shown in FIG. 1, prior to the beginning of a frame n, it determines the maximum frame size Fₘₐₓ(n) in accordance with the current most stringent QoS delay/throughput requirement. For example, it determines Fₘₐₓ(n)=75 slots, rendering 60 slots allocated as the RB for supporting CBR/VBR/ABR traffic, and 15 slots designated as the remaining unreserved bandwidth to be dynamically allocated as favorable bandwidth (FB) of CB for supporting RVR traffic.

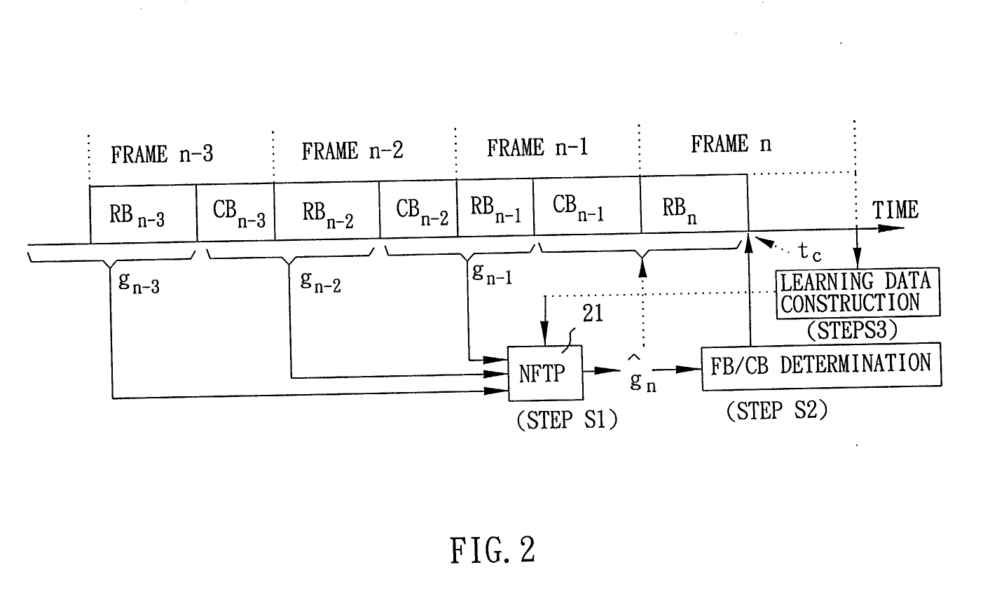

FIG. 2 shows the flow of dynamic granularity control on contention bandwidth allocation in accordance with the method of the present invention. It depicts the process of determining CB allocation for frame n, namely CBₙ, at time t_{c} representing the end of RB of frame n. In the figure, gₙ denotes the normalized offered load of the RVR traffic that is activated within the (CBₙ₋₁, RBₙ) interval, contending for CBₙ.

In the first step (step S1), a neural fuzzy traffic prediction (NFTP) network 21 is used to predicts ĝₙ at time t_{c}, where ĝₙ is the predicted value of gₙ, based on a set of m input values taken from m most-recent gₖ values (k=n−1 to n−m). FIG. 2 shows an NFTP network 21 with three inputs and one output, namely m=3. In step S2, based on ĝₙ, the FBₙ is derived and the CBₙ is ultimately determined. In addition to prediction, at the end of contention period of frame n, learning data is constructed in accordance with the actual bandwidth allocation (step S3) for being input to the NFTP network 21 to perform the learning operation, whereby a better result can be obtained in the next prediction.

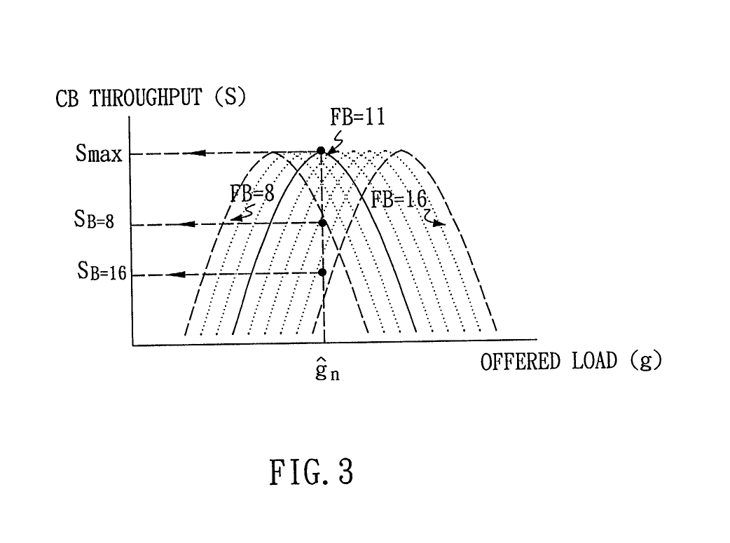

The NFTP network 21 used in step S1 can be implemented with a general neural fuzzy network technique by those people skilled in the art. In step S2, the size of FB for frame n, N_{F}(n), is defined as the number of slots allocated in CBₙ such that the steady-state throughput of contention bandwidth (S) is maximized. Thus, N_{F}(n) is an approximation approach, which is generated as shown in FIG. 3. For a given offered load, there always exists single bandwidth allocation (FB) mapping the offered load to the maximal steady-state throughput. In the figure, for predicted offered load ĝₙ the allocation of 11 slots (favorable bandwidth) yields optimal bandwidth, while the allocations of both smaller number (=8) and larger number (=16) of slots undergo degraded throughput. After determining the FB, the final CB is chosen as the smaller value between the remaining unreserved bandwidth and FB.

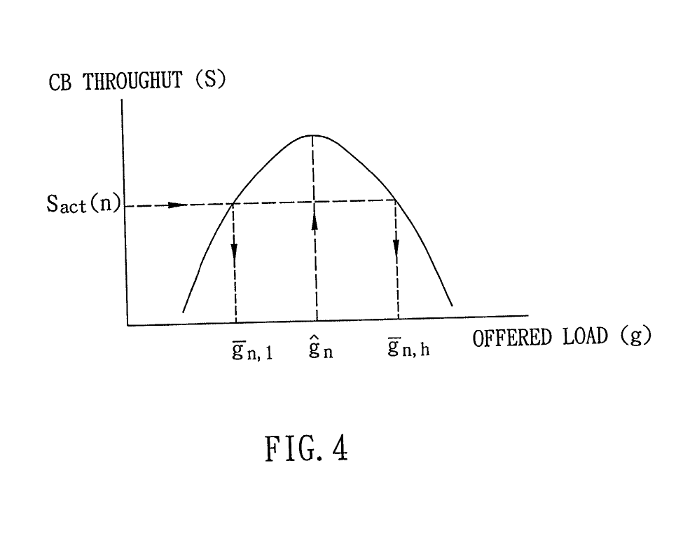

The step S3 is used to identify the real offered load for the training of NFTP network 21 at the end of the contention bandwidth. As shown in FIG. 4, at the end of contention bandwidth CBₙ, one can easily compute the actual achieved channel throughput S_{act}(n). Then, the offered load \overline{g}ₙ can be approximated by the inverse of the steady-state throughput function corresponding to the CB allocated in CBₙ, at point S_{act}(n), namely \overline{g}_{n,1} or \overline{g}_{n,h}. In this example, the CB is designated from the FB (i.e., CB=FB) determined in the previous step, and the inverse values \overline{g}_{n,1} and \overline{g}_{n,h} can be directly obtained.

In view of the foregoing, it is known that the medium access control method of the present invention allocates the RB in accordance with a weight-based scheduling policy. Based on a neural-fuzzy prediction technique, the present method derives the FB implying maximum throughput. The smaller value between the RB and the FB is allocated as the CB of the frame. This results in dynamic change of frame granularity adapting to traffic fluctuation, thereby achieving bandwidth-on-demand while retaining maximal throughput.

Although the present invention has been explained in relation to its preferred embodiment, it is to be understood that many other possible modifications and variations can be made without departing from the spirit and scope of the invention as hereinafter claimed.

What is claimed is:

1. A quality-of-service guaranteed media access control method with dynamic granularity control for local wireless ATM networks, the ATM network transmitting information via a sequence of frames, each frame having reservation bandwidth and contention bandwidth in units of slots for supporting constant bit rate, variable bit rate, available bit rate, and reservation request (RVR) traffic, the method comprising:
(A) using a neural fuzzy traffic prediction network to predicts ĝₙ at a time representing an end of the RB of frame n, where ĝₙ is the predicted value of gₙ, and gₙ denotes a normalized offered load of the reservation request traffic that is activated within interval from the contention bandwidth of frame n−1 to the reservation bandwidth of frame n;
(B) based on ĝₙ, deriving favorable bandwidth of frame n and the contention bandwidth of frame n, wherein the favorable bandwidth is defined as a bandwidth capable of being allocated by remaining unreserved bandwidth of a maximum-sized frame satisfying the most stringent quality of service requirement; the remaining unreserved bandwidth is the bandwidth of the maximum-sized frame subtracted by allocated reservation bandwidth; the favorable bandwidth of frame n is defined as the number of slots allocated in the contention bandwidth of frame n, such that the contention bandwidth has a maximum steady-state throughput;
(C) at the end of contention bandwidth of frame n, constructing learning data in accordance with actual bandwidth allocation for being input to the neural fuzzy traffic prediction network to perform a learning operation.

2. The method as claimed in claim 1, wherein, in step (A), the neural fuzzy traffic prediction networks predicts ĝₙ based on a set of m input values taken from m most-recent gₖ values (k=n−1 to n−m).

3. The method as claimed in claim 2, wherein, in step (B), the contention bandwidth is chosen as the smaller value between the remaining unreserved bandwidth and favorable bandwidth.

4. The method as claimed in claim 3, wherein, in step (C), at the end of contention bandwidth of frame n, actual achieved channel throughput is computed, and then, the offered load can be approximated by inversing a steady-state throughput function corresponding to the contention bandwidth allocated in frame n.

5. The method as claimed in claim 4, wherein the reservation bandwidth is provided for supporting for supporting the constant bit rate, variable bit rate, and available bit rate traffic, and the contention bandwidth is provided for supporting the reservation request traffic.

6. The method as claimed in claim 4, wherein each slot of the frame includes an ATM cell, and control fields of guard times and sync.
